(19) United States
(12) Patent Application Publication
(10) Pub. No.: US 2010/0180199 A1
(43) Pub. Date: Jul. 15, 2010

(54) DETECTING NAME ENTITIES AND NEW WORDS

(75) Inventors: Jun Wu, Saratoga, CA (US); Zheng Huang, Redwood City, CA (US); Xin Zheng, Beijing (CN); Dekang Lin, Cupertino, CA (US); Hangjun Ye, Beijing (CN); Yingyu Wan, Beijing (CN); Po Zhang, Beijing (CN)

Correspondence Address: FISH & RICHARDSON P.C., PO BOX 1022, MINNEAPOLIS, MN, 55440-1022, US

(73) Assignee: GOOGLE INC., Mountain View, CA (US)

(21) Appl. No.: 12/602,646

(22) PCT Filed: Jun. 1, 2007
(86) PCT No.: PCT/CN07/01755

§ 371 Date: Dec. 1, 2009

(51) Int. Cl. G06F 17/27

(52) U.S. Cl. 715/259; 715/256

(57) ABSTRACT

Various aspects can be implemented for detecting name entities and/or new words from input entries. In general, one aspect can be a method that includes receiving an input entry comprising a text string. The method also includes identifying segmentation information from the input entry. The method further includes generating a candidate text string from the text string of the input entry based on the segmentation information. Other implementations of this aspect includes corresponding systems, apparatus, and processing engines.

### TECHNICAL FIELD

This disclosure generally relates to detecting name entities and/or new words from input entries.

### BACKGROUND

Detecting (e.g., identifying and extracting) name entities and/or new words (herein after, “NENW”) can be useful for many applications such as spelling correction, ideographic character input, machine translation, web search, speech recognition, optical character recognition (OCR) or the like. A name entity (or named entity) can include a proverb, an idiom or a proper noun referring to a person, a location, an organization, or other unique entity. A new word can be a semantically meaningful sequence of characters not included in current dictionaries, e.g., a word borrowed from a different language, or a word adopted from the scientific field. For example, the term “Blu-ray” is a new word that describes a blue laser-based, high-density optical disc format for the storage of digital media. Once a new word is generally accepted, it can become part of the lexicon and be included in dictionaries.

### SUMMARY

This specification describes various aspects relating to detecting name entities and/or new words from input entries, e.g., search queries and user input documents. In general, one aspect can be a method that includes receiving an input entry comprising a text string. The method also includes identifying segmentation information from the input entry. The method further includes generating a candidate text string from the text string of the input entry based on the segmentation information. Other implementations of this aspect include corresponding systems, apparatus, and processing engines.

Another general aspect can be a system that includes an input entry component configured to allow a user to enter a text string. The system also includes means for generating a candidate text string from the input text string. The system further includes a database configured to determine if the candidate text string is already in the database, and store the candidate text string in the database when the candidate text string is not already stored in the dictionary or the database.

These and other general aspects can optionally include one or more of the following specific aspects. The method can include associating the entire text string with the candidate text string when the segmentation information is not available. The method can also include generating a normalized count for the candidate text string, and comparing the candidate text string with a dictionary. The method can further include storing the candidate text string as a canonic text string in a database when the comparing determines that the candidate text string is not already stored in the dictionary. The method can additionally include comparing the candidate text string with the database, determining if the candidate text string is misspelled based on the comparing, and generating an alternative text string when the candidate text string is misspelled.

The input entry can include a user query for a search engine, a script for instant messaging, or a user input for an input method editor. The text string can include one or more words in a non-Roman language. The non-Roman language can be Chinese, Japanese, or Korean language. The segmentation information can include a user-generated segmentation that can be used to emphasize or distinguish between words or phrases in the text string. The candidate text string can include one or more name entities or new words. The dictionary can include a proper noun dictionary. The user-generated segmentation can include a space, a tab, a quotation mark, a parenthesis, or a punctuation mark. The name entities can include idioms, proverbs, and names of people, organization, or places. The new words can include words not currently included in dictionaries.

Particular aspects can be implemented to realize one or more of the following advantages. NENW (name entities and/or new words) in non-Roman languages can be detected (e.g., extracted and identified) from input entries (e.g., search queries, instant messaging “IM” scripts, user typed sentences in editors, such as Microsoft Word) based on, e.g., one or more user-generated segmentations. A user-generated segmentation can be a sequence of one or more user-typed characters delimited by spaces, tabs, quotation marks, parentheses, or any punctuation marks, explicitly or implicitly.

Coverage of spelling corrections in input entries can be increased based on the detected NENW. Additionally, new name entities/words can be detected automatically without relying on human annotated data. A scalable spelling error correction database can be used to incorporate newly detected name entities/words. Thus, high accuracy in spelling correction can be achieved. Furthermore, better word suggestions for input method editors (IME) for non-Roman characters, e.g., Chinese, Japanese and Korean (CJK) characters, can be achieved. An improved IME can be used to differentiate words having the same or similar pronunciations. For instance, a Chinese IME can suggest to the user either [symbol] or [symbol] given different last names. Thus, detection of NENW can also be useful in building an adaptive IME dictionary for CJK languages.

A more targeted search query result potentially also can be achieved because false-positive results from using keyword-based searches can be avoided. For example, when a user enters the phrase “New York Traveling” in an input query for a search engine, the name entity “New York” can be detected. Rather than returning search results that are false positives, such as web pages containing the words “New” and “York” separately, the desired information about traveling for the city of New York can be provided to the user. Additionally, the ability to provide targeted search query results can be desirable for search queries generated using handheld devices, such as mobile phones, personal digital assistants (PDAs), two-way pagers, or smartphones.

The general and specific aspects can be implemented using a system, method, or a computer program, or any combination of systems, methods, and computer programs. The details of one or more implementations are set forth in the accompanying drawings and the description below. Other features, aspects, and advantages will be apparent from the description, the drawings, and the claims.

### DESCRIPTION OF DRAWINGS

These and other aspects will now be described in detail with reference to the following drawings.

FIG. 1 is a conceptual diagram of a system that generates a database by detecting NENW from input entries.

FIG. 2A shows various candidate NENW in input entries.

FIG. 2B shows a list of candidate NENW and their associated occurrences/counts from the input entries of FIG. 2A.

FIG. 2C shows a list of candidate NENW and their associated normalized counts from the input entries of FIG. 2A.

FIG. 3 is a flow chart illustrating, a process of detecting name entities/new words from input entries.

FIG. 4 is a flow chart illustrating a process of using the detected name entities/new words from input entries for spelling correction.

FIG. 5 is a block diagram of computing devices and systems.

Like reference symbols in the various drawings indicate like elements.

### DETAILED DESCRIPTION

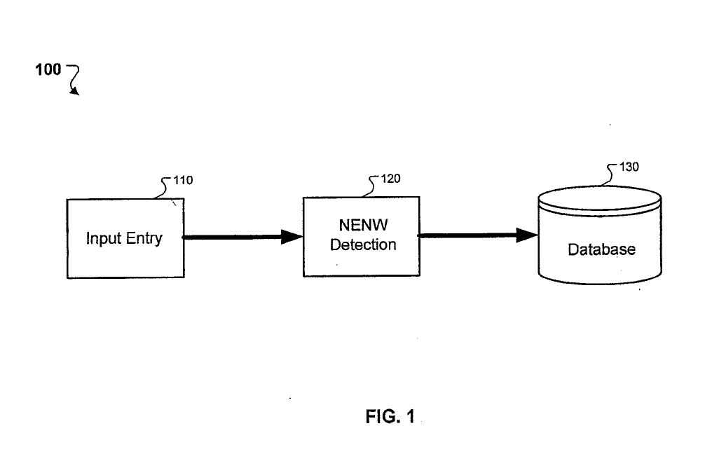

FIG. 1 is a conceptual diagram of a system 100 that detects name entities and/or new words (NENW) from input entries. The system 100 has an input entry component 110, which can, e.g., include query boxes in a search engine (e.g., the Google search engine) that allows a user to enter search queries. The system 100 also has an NENW detection component 120, which can, e.g., identify and extract potential NENW from the input entry component 110. As will be discussed in further detail below, the detection of potential NENW can be based on, e.g., user-generated segmentations in the search queries. These segmentations can be spaces, quotation marks, parentheses, or other punctuation marks that a user may utilize in order to emphasize the NENW.

The system 100 further includes a database 130, which can be, e.g., a spelling correction and/or IME database that includes canonic NENW. As will be discussed in further detail below, not all the potential NENW identified by the NENW detection component 120 become canonic NENW. The determination of whether an identified name entity/new word is truly a name entity/new word can be based on normalized counts and session logs of search queries. In this manner, potential NENW submitted by users in the input entry component 110 can be detected (e.g., identified and extracted) by the NENW detection component 120.

The detected NENW can also be added to the database 130 (e.g., a spelling correction/IME database). Thus, the database 130 can be scalable because new name entities/words (e.g., names of new music artists or new songs, and new idioms or proverbs) can be detected and stored in the database. Furthermore, a high coverage of spelling error correction and/or IME suggestion can be achieved because the database can easily incorporate new name entities/words.

In some Roman languages, such as English, capitalization information can play a key role in NENW detection. In some non-Roman languages, especially in ideographic languages like Chinese, Japanese and Korean (CJK), the characters have no upper and lower cases but one written form. Further, these CJK languages typically do not use spaces between words in their written form. Thus, NENW detection can be difficult in these CJK languages.

Additionally, spelling correction for non-Roman languages such as CJK languages can be complex and challenging. Spelling correction generally includes detecting erroneous words and determining appropriate replacements for the erroneous words. Most spelling errors in alphabetical, i.e., Roman-based, languages such as English are either out-of-vocabulary (misspelled) words, e.g., “thna” rather than “than,” or valid words improperly used in its context, e.g., “stranger then” rather than “stranger than.” Spell checkers that detect and correct out-of-vocabulary spelling errors in Roman-based languages are well known.

However, non-Roman based languages such as CJK languages have no invalid characters encoded in any computer character set, e.g., Chinese GB2312 and UTF-8 character set, such that most spelling errors are valid characters improperly used in context rather than out-of-vocabulary spelling errors. In Chinese, Japanese and Korean, the correct use of characters/words can generally only be determined in context. For example, both [symbol] and [symbol] can be used as first names in Chinese. However, the most popular full name incorporating them is [symbol] (the name of a general) and [symbol] (the name of a singer), respectively. Thus, an effective spell checker for a non-Roman based language should make use of contextual information to determine which characters and/or words in context are not suitable.

Besides spelling correction, system 100 can be useful in building an adaptive IME dictionary for CJK languages. For example, inputting and processing Chinese language text on a computer can be very difficult. This is due in part to the sheer number of Chinese characters as well as the inherent problems in the Chinese language with text standardization, multiple homonyms, and invisible (or hidden) word boundaries that create ambiguities which can make Chinese text processing difficult.

One common method for inputting Chinese language text into a computer system is using phonetic input, e.g. pinyin. Pinyin uses Roman characters and has a vocabulary listed in the form of multiple syllable words. However, the pinyin input method can result in a homonym problem in Chinese language processing. In particular, as there are only approximately 1,300 different phonetic syllables (as can be represented by pinyin) with tones and approximately 410 phonetic syllables without tones representing the tens of thousands of Chinese characters (Hanzi), one phonetic syllable, with or without tone, may correspond to many different Hanzi. For example, the pronunciation of “yi” in Mandarin can correspond to over 100 Hanzi. This can create ambiguities when translating the phonetic syllables into Hanzi.

Many phonetic input systems use a multiple-choice method to address this homonym problem. Once the user enters a phonetic syllable, a list of possible Hanzi characters with the same pronunciation is displayed and suggested to the user. However, the process of inputting and selecting the corresponding Hanzi for each syllable can be slow, tedious, and time consuming. Other phonetic input systems are based on determining the likelihoods of each possible Hanzi character based on the adjacent Hanzi characters. The probability approach can further be combined with grammatical constraints.

However, the accuracy of the conversion from phonetic to Hanzi of such methods is often limited when applied to literature (e.g., with many descriptive sentences and idioms) and/or spoken or informal language as is used on the web in user queries and/or bulletin board system (BBS) posts, for example. In addition, low dictionary coverage often contributes to the poor conversion quality in spoken language. Therefore, using system 100, an adaptive IME dictionary can be built and better word suggestions in IME for non-Roman characters, e.g., CJK characters, can be achieved.

In addition to spelling correction and IME, system 100 can also use the detected named entities to provide more targeted search results. This can be illustrated with the following example. Suppose that a user is interested in finding out more information about traveling for the city of New York. She then enters the phrase “New York Traveling” in an input query for a search engine. Using the traditional keyword-based searches, the search engine may return search results that are false positives, such as web pages containing the words “New” and

“York”, instead of recognizing that “New York” is a name entity. In contrast, system 100 can detect that “New York” is a name entity, and return search results targeted to the information that a user desires.

Additionally, the ability to provide targeted search query results can be desirable for search queries generated using handheld devices, such as mobile phones, PDAs, two-way pagers, or smartphones. In contrast with a traditional web search from a desktop computer, search queries generated from handheld devices can be more targeted to a particular file for download or merchandize for purchase. For example, users of handheld devices typically submit search queries based on NENW, such as downloading a song or a picture of a certain musician, requesting information about a certain movie or a certain person, or requesting information about a new product.

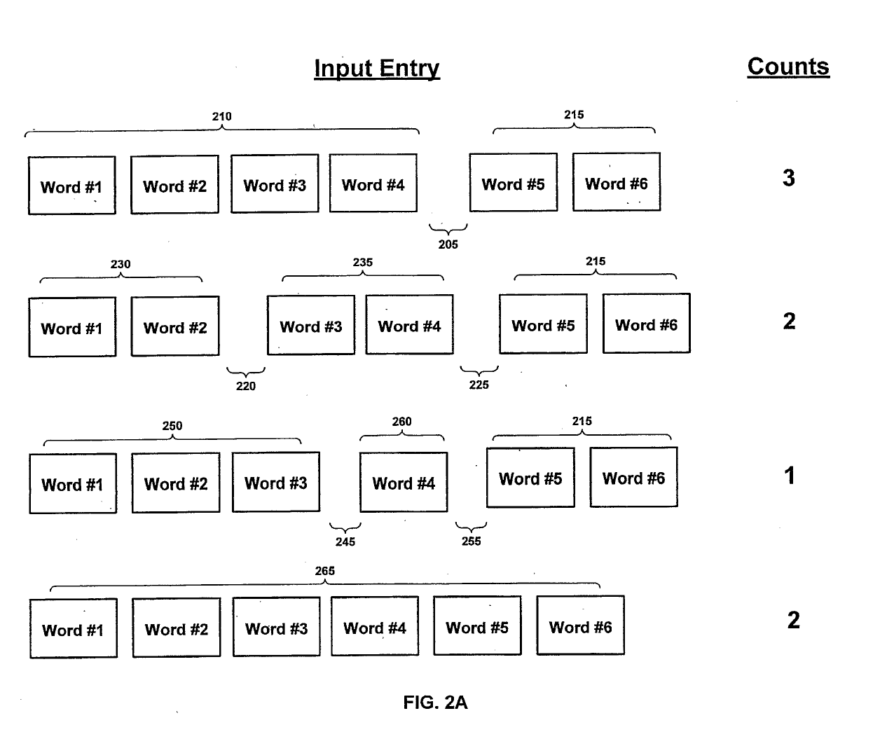

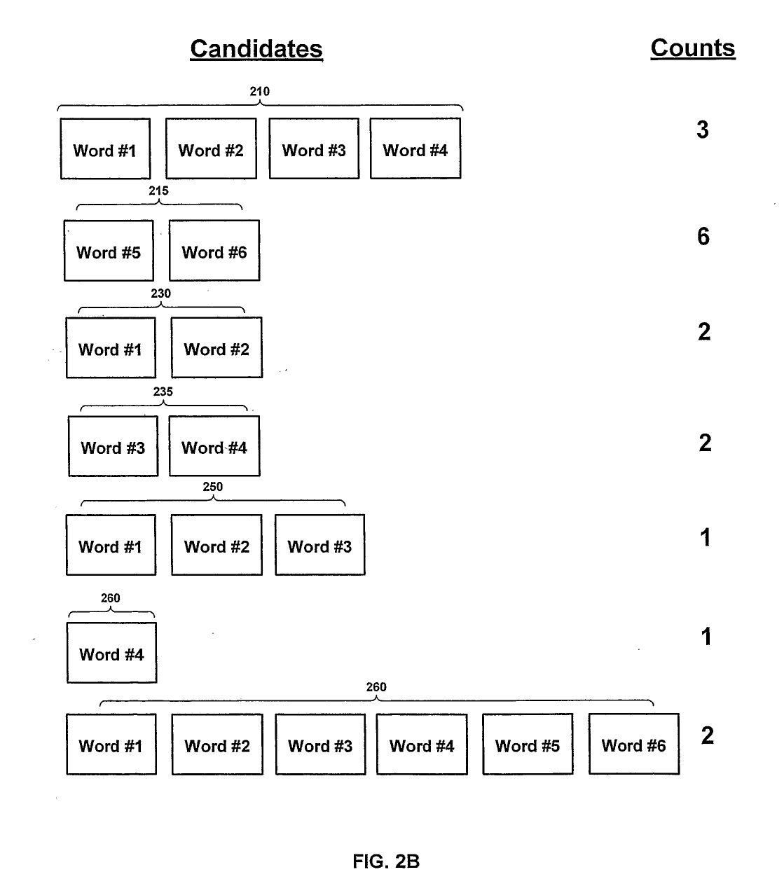

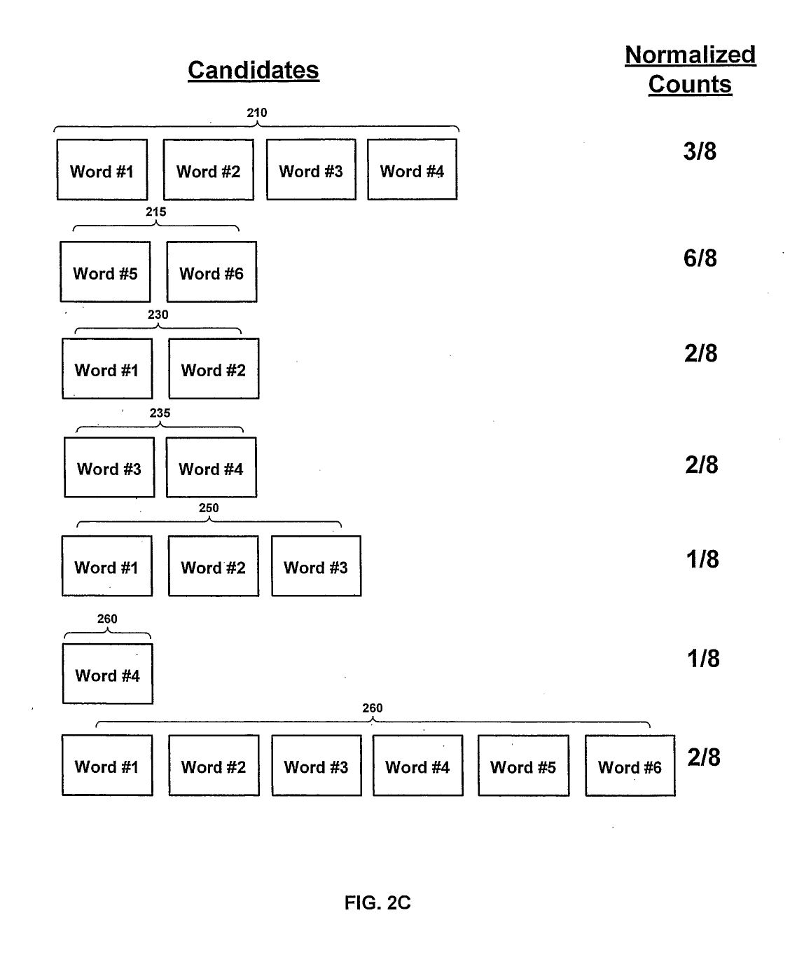

An operational overview of how system 100 detects NENW can be illustrated with the following examples shown in FIGS. 2A-2C. FIG. 2A shows various text strings entered by users in input entries. The example in FIG. 2A supposes that there are eight input entries, each input entry containing a sequence of six characters/words in a non-Roman-based language, such as Chinese. For example, the sequence of six Chinese characters/words in the text string can be [symbol] , which means [symbol] the mayor of the city of Shanghai. In Chinese, each character can also represent a word; for example, [symbol] (which is one of the six characters in the example text string) is a Chinese character that has a meaning of the word, “city.”

As noted above, the non-Roman-based CJK languages do not have capitalized characters. Furthermore, Chinese and Japanese typically have no space between words and sentences, and it can be difficult to detect candidate NENW in these languages. However, the users sometimes enter segmentations (for example, spaces, tabs, quotation marks, or other punctuation marks) in the input entries to point out the NENW that they want to emphasize or distinguish from the rest of the input text string. The input entries shown in FIG. 2A display various text strings, each containing a sequence of six characters/words, entered by the users for input entries. From these text strings, segmentation information can be identified and possible candidate NENW can be generated.

For example, in the first input entry (which occurs 3 times among the 8 input entries; thus giving this input entry a count of 3), the user has entered a segmentation 205 to separate the substring containing Word #1, Word #2, Word #3, and Word #4 (e.g., [symbol] ) from another substring containing Word #5 and Word #6 (e.g., [symbol] ). In one implementation, system 100 can identify this user-generated segmentation 205 in the first input text string. Further, using the identified segmentation 205, system 100 can generate two candidate NENW, which are candidate name entity/new word 210 and candidate name entity/new word 215. The segmentation 205 can be entered by the user intentionally or inadvertently. As will be discussed further below, regardless of whether the segmentation 205 is intentional or inadvertent, system 100 can generate a canonic name entity/new word based, e.g., on an entity or word that has a high normalized count.

Further, in the second input entry (which occurs twice among the 8 input entries; thus giving this input entry a count of 2), the user has entered a segmentation 220 to separate the substring containing Word #1 and Word #2 (e.g., [symbol] ) from another substring containing Word #3 and Word #4 (e.g., [symbol] ). [symbol] Additionally, the user has entered another segmentation 225 to separate the substring containing Word #3 and Word #4 (e.g., [symbol] ) from another substring containing Word #5 and Word #6 (e.g., [symbol] ). In one implementation, system 100 can identify both user-generated segmentations 220 and 225 in the second input text string. Further, using the identified segmentations 220 and 225, system 100 can generate three candidate NENW, which are candidate NENW 230, 235, and 215.

In the third input entry (which occurs once among the 8 input entries; thus giving this input entry a count of 1), the user has entered a segmentation 245 to separate the substring containing Word #1, Word #2, and Word #3 (e.g., [symbol] ) from another substring containing Word #4 (e.g., [symbol] ). Additionally, the user has entered another segmentation 255 to separate the substring containing Word #4 (e.g., [symbol] ) from another substring containing Word #5 and Word #6 (e.g., [symbol] ). In one implementation, system 100 can identify both user-generated segmentations 245 and 255 in the third input text string. Further, using the identified segmentations 245 and 255, system 100 can generate three candidate NENW, which are candidate NENW 250, 260, and 215.

In the fourth input entry (which occurs twice among the 8 input entries; thus giving this input entry a count of 2), the user has entered no segmentation. In one implementation, system 100 can determine that no user-generated segmentation exists. In this manner, the candidate name entity/new word does not get generated based on user-generated segmentation. However, in this case, system 100 can associate the entire phrase or text string of the fourth input entry with the candidate name entity/new word 265, which contains Word #1, Word #2, Word #3, Word #4, Word #5, and Word #6 (e.g., [symbol] ).

The number of possible candidate NENW, given a sequence of characters/words in a text string, can be represented mathematically. Suppose a sequence with N characters (e.g., “ABC”, N=3) can generate G(N) candidate words, and a new character (e.g., “D”) is added to the sequence. That new character can be combined with any of N candidate words in the previous sequence to generate N new candidate words. Further, that new character itself can be a single character word. For example, when the new character “D” is added to the sequence “ABC”, there can be four new candidate words: “ABCD”, “BCD”, “CD”, and “D” by itself. Therefore, N+1 new candidates can be generated when adding one more character to a sequence of N characters.

In other words, a recursive relationship of G(N+1)=G(N)+(N+1), and G(1)=1 can be obtained from a sequence of N characters. An equation, G(N)=N*(N+1)/2, can be derived from this recursive relationship. In this manner, there can be N*(N+1)/2 (where N is a positive integer) possible candidate NENW in an entry containing N number of characters. For example, if there are four words in the input entry (N=4), then the number of possible candidate NENW is 10. Similarly, in examples shown in FIG. 2A, there are six characters/words in the input entry (N=6). Thus, there can be 21 possible candidate NENW.

FIG. 2B shows a list of candidate NENW and their associated occurrences/counts from the input entries of FIG. 2A. As shown in FIG. 2B, there are seven candidate NENW generated from a total of eight input entries (each entry containing a sequence of six characters/words) with four different input text strings in FIG. 2A. The seven candidate NENW include candidate name entity/new word 210, which has a count of 3 because it occurred 3 times in 8 input entries. Candidate name entity/new word 215 has a count of 6 because it occurred 6 times in 8 input entries. Candidate name entity/new word 230 has a count of 2 because it occurred 2 times in 8 input entries.

Further, candidate name entity/new word 235 has a count of 2 because it occurred 2 times in 8 input entries. Candidate name entity/new word 250 has a count of 1 because it occurred once in 8 input entries. Candidate name entity/new word 260 also has a count of 1 because it occurred once in 8 input entries. Lastly, candidate name entity/new word 260 has a count of 2 because it occurred 2 times in 8 input entries.

Thus, the system 100 can accumulate these occurrences or counts of candidate NENW in input entries and determine which of the candidate NENW can become canonic NENW and be stored in the database 130. In one implementation, the system 100 can have a threshold number of counts so that when the candidate name entity/new word count is above the threshold number, the candidate name entity/new word becomes a canonic name entity/new word. The occurrences can be either original numbers from user inputs, or normalized/derived numbers according to appearance of each individual character or character sequence.

For example, even though the occurrence of [symbol] (which means “I am” in Chinese) has an extremely high occurrence in user inputs, it can have a low normalized frequency, when normalized by the occurrence of characters [symbol] and [symbol] individually. In one implementation, the normalized frequency used for determining canonic NENW can be calculated using the following formula: h(c1,c2)*log{ƒ(c1,c2)/[ƒ(c1)*ƒ(c2)]}; where ƒ( )is a function (linear function with respect occurrence) denoting the relative frequency of a particular word or phrase; and h( ) is a monotonic increasing function with respect to occurrence. For example, h( ) can be any function as long as it increases monotonically with ƒ( ) such as h(c1,c2)=ƒ(c1, c2), or h(c1,c2)=log ƒ(c1,c2). In this manner, h( ) function can be chosen so that the most common combination of characters is generated as the candidate name entity/new word.

Alternatively, system 100 can use query logs of user input entries to determine if the candidate name entity/new word should become a canonic name entity/new word. For example, when a name entity/new word is not identified and misspelled by a user in a search query, wrong query results (or none) are presented. However, in such case, the user can manually correct the spelling of the name entity/new word in order to obtain the desired search result. In one implementation, system 100 can use this history of successful query results and/or user corrections to generate possible candidate NENW and augment the database 130.

FIG. 2C shows a list of candidate NENW and their associated normalized counts from the input entries of FIG. 2A. In one implementation, system 100 can use a normalized count for the candidate name entity/new word to avoid generating non-semantically meaningful common sequences of characters. The normalized count can be generated by calculating the ratio of the counts of the candidate name entity/new word over a given number of input entries. In this manner, the system 100 can associate candidate name entity/new word with high normalized count as canonic NENW.

As shown in FIG. 2C, candidate name entity/new word 210 has a normalized count of ⅜, or 0.375, because it occurred 3 times in 8 input entries. Candidate name entity/new word 215 has a normalized count of 6/8, or 0.75, because it occurred 6 times in 8 input entries. Candidate name entity/new word 230 has a normalized count of 2/8, or 0.25, because it occurred 2 times in 8 input entries. Candidate name entity/new word 235 has a normalized count of 2/8, or 0.25, because it occurred 2 times in 8 input entries. Candidate name entity/new word 250 has a normalized count of ⅛, or 0.125, because it occurred once in 8 input entries. Candidate name entity/new word 260 also has a normalized count of ⅛, or 0.125, because it occurred once in 8 input entries. Lastly, candidate name entity/new word 260 has a normalized count of 2/8, or 0.25, because it occurred 2 times in 8 input entries.

As noted above, candidate name entity/new word that has a high normalized count can become a canonic name entity/new word. In one implementation, system 100 can be configured so that all candidate NENW having normalized counts above 0.5 can become canonic NENW, and be stored in the database 130. In such case, of the candidate NENW shown in FIG. 2C, system 100 would generate a canonic name entity/new word based on the candidate name entity/new word 215, which has a normalized count of 0.75.

Furthermore, the canonic name entity/new word generated using the threshold normalized count described above may not always represent the correct spelling of a name entity/new word. For example, suppose that a high number of search queries contain the term “blue-ray” and a candidate new word is generated based on, e.g., user-generated segmentation in the input text string. Additionally, suppose that the normalized count of the candidate new word, “blue-ray”, is 0.8 because of its high frequency of occurrences. The candidate new word, “blue-ray”, would have a normalized count above the threshold value (say, 0.5) and become a canonic new word, which can be stored in a database, e.g., database 130 of FIG. 1. This is the case despite the fact that the correct spelling should be “blu-ray” and most of the users have misspelled it as “blue-ray.” In this manner, system 100 can detect NENW even when they are frequently misspelled by the users.

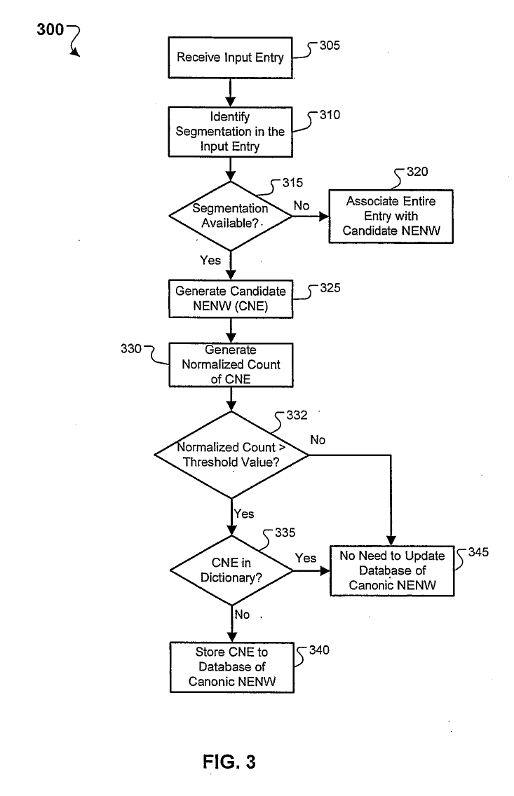

FIG. 3 is a flow chart illustrating a process 300 of detecting NENW from input entries. At 305, process 300 receives an input entry, which can be, e.g., a search query for an online search engine such as Google search engine, or an input method editor, as noted above. At 310, process 300 identifies segmentation information, e.g., the user-generated segmentation in the input entry. As noted above, the user-generated segmentation in the input entry can be a punctuation mark, a space, or any other marks that can be used to distinguish or emphasize between two words or phrases.

At 315, if the segmentation information is available (e.g., one or more user-generated segmentations are available), then at 325, candidate NENW are generated based on the segmentation information. Examples of how the candidate NENW can be generated are described in detail and shown in FIGS. 2A-2C above. On the other hand, if there is no segmentation information available in the input entry, process 300 associates the entire input entry text string with the candidate name entity/new word. For example, this would be similar to the fourth input entry shown in FIG. 2A, which does not have any user-generated segmentation.

At 330, process 300 generates normalized counts for each candidate name entity/new word, regardless of whether the NENW are from entries with user-generated segmentations or entries without user-generated segmentations. As noted above in FIG. 2C, the normalized count for each candidate name entity/new word can be generated by calculating the ratio of the counts of the candidate name entity/new word over a given number of input entries containing the sequence of characters/words.

At 332, process 300 determines whether the normalized count of the candidate name entity/new word is greater than a predetermined threshold value. If the normalized count does not exceed the threshold value, at 345, the candidate name entity/new word is not stored as a canonic name entity/new word. For example, the candidate name entity/new word can be non-semantically meaningful common sequences of characters, as described above.

If, on the other hand, the normalized count exceeds the threshold value, at 335, process 300 determines whether the candidate name entity/new word is already included in a dictionary, e.g., a proper noun dictionary, which can include a list of predetermined and/or known NENW. This is because many of the candidate NENW may have already been known and included in some dictionaries. For instance, [symbol] , or [symbol] are proper nouns that are known, and these words don't need to be added to the canonic NENW database.

If the candidate name entity/new word is already known in the dictionary (e.g., a proper noun) or stored in the database, at 345, there is no need to update the database of canonic NENW (e.g., the database 130 of FIG. 1). However, if the candidate name entity/new word is not known in the dictionary or stored in the database, process 300 stores the candidate name entity/new word to the database as a canonic name entity/new word, at 340. In this manner, the database can be scalable because new NENW (e.g., names of a new music artist or a new song) can be detected and stored in the database. Furthermore, a high coverage of spelling error correction or input method suggestions can be achieved because the database can easily incorporate new name entities/words.

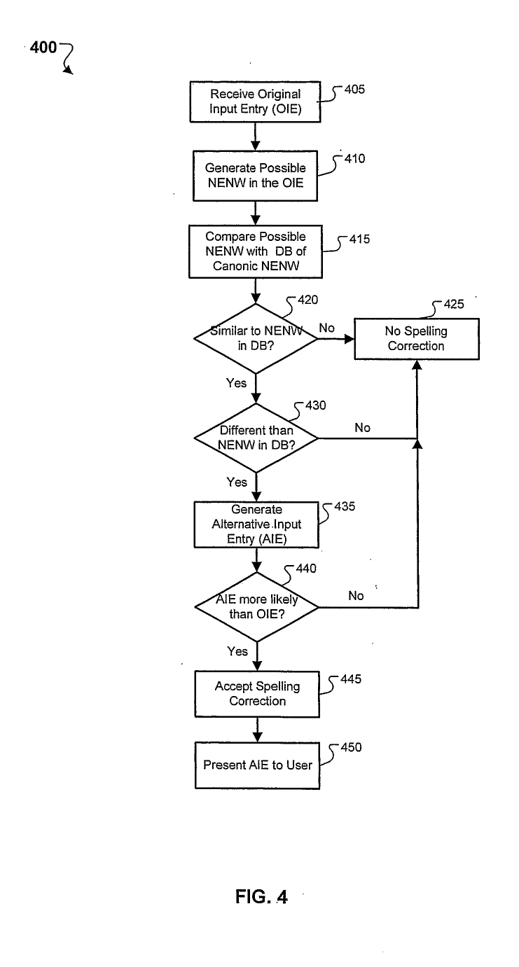

FIG. 4 is a flow chart illustrating a process 400 of using the extracted NENW from input entries for spelling correction. At 405, process 400 receives an original input entry (OIE), which can be, e.g., a search query using the Google search engine. At 410, process 400 generates possible NENW in the original input entry. At 415, process 400 compares possible NENW with a database of canonic NENW, which can be, e.g., the database mentioned in 340 shown in FIG. 3.

At 420, process 400 determines whether the possible NENW are similar to the NENW in the canonic database. In one implementation, the similarity measurement can be configured to allow for editing distances of a predetermined number of text substrings (e.g., characters). For example, suppose that a canonic entity is [symbol] and some users type [symbol] instead in the input entries. In such case, process 400 can compare all four characters in the text string for the similarity measurement.

If the possible name entity/new word is not similar to any of the NENW in the canonic database, at 425, process 400 does not implement any spelling correction. For example, if the possible name entity/new word is a Chinese phrase [symbol] , no spelling correction will be performed when compared with the canonic entity [symbol] in the database. However, if the possible name entity/new word is similar to the NENW in the canonic database, at 430, process 400 determines whether the possible name entity/new word is different than any of the canonic NENW in the database. If not, at 425, process 400 does not implement any spelling correction because the possible name entity/new word is already included in the canonic NENW database and therefore it already has a correct spelling.

However, if the possible name entity/new word is similar but different from the canonic NENW database, at 435, process 400 generates an alternative text string for the alternative input entry (AIE) by replacing the possible name entity/new word with the similar canonic name entity/new word obtained from the database. At 440, process 400 determines whether the AIE is more likely to occur in search queries than the OIE. For example, the likelihood of the query [symbol] can be one order of magnitude higher than that of [symbol] , according to the statistics from user input data. If not, at 425, process 400 does not implement any spelling correction. On the other hand, if AIE is more likely to occur than OIE, at 445, process 400 accepts the spelling correction. At 450, process 400 presents the AIE to the user as a suggestion for spelling correction in the search query.

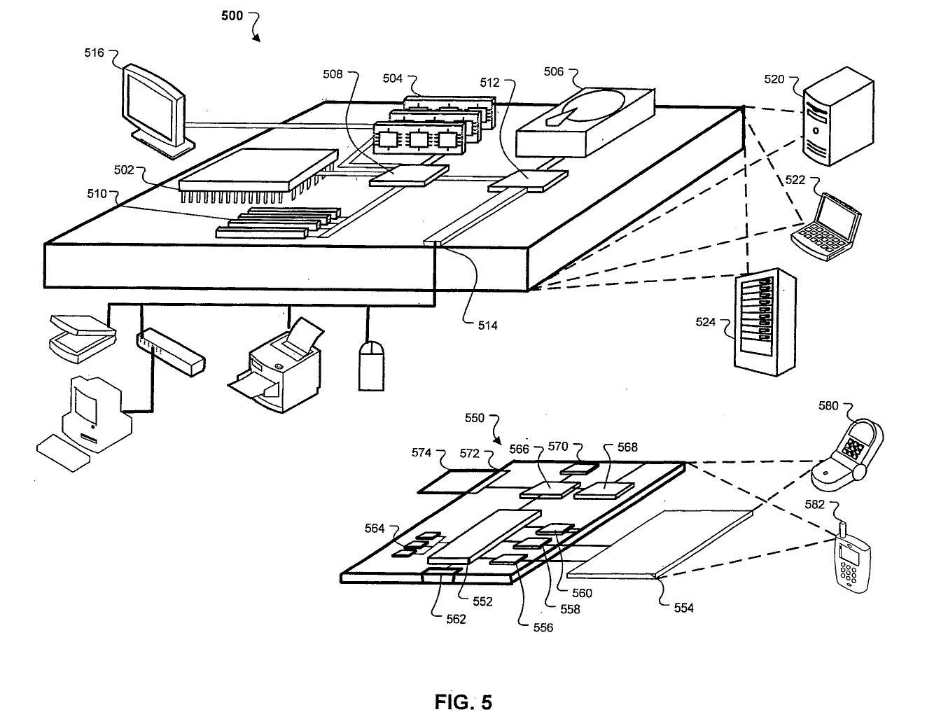

FIG. 5 is a block diagram of computing devices and systems 500, 550 that can be used, e.g., to implement system 100. Computing device 500 is intended to represent various forms of digital computers, such as laptops, desktops, workstations, personal digital assistants, servers, blade servers, mainframes, and other appropriate computers. Computing device 550 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 500 includes a processor 502, memory 504, a storage device 506, a high-speed interface 508 connecting to memory 504 and high-speed expansion ports 510, and a low speed interface 512 connecting to low speed bus 514 and storage device 506. Each of the components 502, 504, 506, 508, 510, and 512, are interconnected using various busses, and can be mounted on a common motherboard or in other manners as appropriate. The processor 502 can process instructions for execution within the computing device 500, including instructions stored in the memory 504 or on the storage device 506 to display graphical information for a GUI on an external input/output device, such as display 516 coupled to high speed interface 508. In other implementations, multiple processors and/or multiple buses can be used, as appropriate, along with multiple memories and types of memory. Also, multiple computing devices 500 can be connected, with each device providing portions of the necessary operations (e.g., as a server bank, a group of blade servers, or a multi-processor system).

The memory 504 stores information within the computing device 500. In one implementation, the memory 504 is a computer-readable medium. In one implementation, the memory 504 is a volatile memory unit or units. In another implementation, the memory 504 is a non-volatile memory unit or units.

The storage device 506 is capable of providing mass storage for the computing device 500. In one implementation, the storage device 506 is a computer-readable medium. In various different implementations, the storage device 506 can be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 504, the storage device 506, memory on processor 502, or a propagated signal.

The high speed controller 508 manages bandwidth-intensive operations for the computing device 500, while the low speed controller 512 manages lower bandwidth-intensive operations. Such allocation of duties is exemplary only. In one implementation, the high-speed controller 508 is coupled to memory 504, display 516 (e.g., through a graphics processor or accelerator), and to high-speed expansion ports 510, which can accept various expansion cards (not shown). In the implementation, low-speed controller 512 is coupled to storage device 506 and low-speed expansion port 514. The low-speed expansion port, which can include various communication ports (e.g., USB, Bluetooth, Ethernet, wireless Ethernet) can be coupled to one or more input/output devices, such as a keyboard, a pointing device, a scanner, or a networking device such as a switch or router, e.g., through a network adapter.

The computing device 500 can be implemented in a number of different forms, as shown in the figure. For example, it can be implemented as a standard server 520, or multiple times in a group of such servers. It can also be implemented as part of a rack server system 524. In addition, it can be implemented in a personal computer such as a laptop computer 522. Alternatively, components from computing device 500 can be combined with other components in a mobile device (not shown), such as device 550. Each of such devices can contain one or more of computing device 500, 550, and an entire system can be made up of multiple computing devices 500, 550 communicating with each other.

Computing device 550 includes a processor 552, memory 564, an input/output device such as a display 554, a communication interface 566, and a transceiver 568, among other components. The device 550 can also be provided with a storage device, such as a microdrive or other device, to provide additional storage. Each of the components 550, 552, 564, 554, 566, and 568, are interconnected using various buses, and several of the components can be mounted on a common motherboard or in other manners as appropriate.

The processor 552 can process instructions for execution within the computing device 550, including instructions stored in the memory 564. The processor can also include separate analog and digital processors. The processor can provide, for example, for coordination of the other components of the device 550, such as control of user interfaces, applications run by device 550, and wireless communication by device 550.

Processor 552 can communicate with a user through control interface 558 and display interface 556 coupled to a display 554. The display 554 can be, for example, a TFT LCD display or an OLED display, or other appropriate display technology. The display interface 556 can comprise appropriate circuitry for driving the display 554 to present graphical and other information to a user. The control interface 558 can receive commands from a user and convert them for submission to the processor 552. In addition, an external interface 562 can be provide in communication with processor 552, so as to enable near area communication of device 550 with other devices. External interface 562 can provide, for example, for wired communication (e.g., via a docking procedure) or for wireless communication (e.g., via Bluetooth or other such technologies).

The memory 564 stores information within the computing device 550. In one implementation, the memory 564 is a computer-readable medium. In one implementation, the memory 564 is a volatile memory unit or units. In another implementation, the memory 564 is a non-volatile memory unit or units. Expansion memory 554 can also be provided and connected to device 550 through expansion interface 552, which can include, for example, a SIMM card interface. Such expansion memory 574 can provide extra storage space for device 550, or can also store applications or other information for device 550. Specifically, expansion memory 574 can include instructions to carry out or supplement the processes described above, and can include secure information also. Thus, for example, expansion memory 574 can be provide as a security module for device 550, and can be programmed with instructions that permit secure use of device 550. In addition, secure applications can be provided via the SIMM cards, along with additional information, such as placing identifying information on the SIMM card in a non-hackable manner.

The memory can include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, memory on processor 552, or a propagated signal.

Device 550 can communicate wirelessly through communication interface 566, which can include digital signal processing circuitry where necessary. Communication interface 566 can provide for communications under various modes or protocols, such as GSM voice calls, SMS, EMS, or MMS messaging, CDMA, TDMA, PDC, WCDMA, CDMA2000, or GPRS, among others. Such communication can occur, for example, through radio-frequency transceiver 568. In addition, short-range communication can occur, such as using a Bluetooth, WiFi, or other such transceiver (not shown). In addition, GPS receiver module 570 can provide additional wireless data to device 550, which can be used as appropriate by applications running on device 550.

Device 550 can also communication audibly using audio codec 560, which can receive spoken information from a user and convert it to usable digital information. Audio codex 560 can likewise generate audible sound for a user, such as through a speaker, e.g., in a handset of device 550. Such sound can include sound from voice telephone calls, can include recorded sound (e.g., voice messages, music files, etc.) and can also include sound generated by applications operating on device 550.

The computing device 550 can be implemented in a number of different forms, as shown in the figure. For example, it can be implemented as a cellular telephone 580. It can also be implemented as part of a smartphone 582, personal digital assistant, or other similar mobile device.

According to the first aspect, the present application provides a computer-implemented method, comprising: receiving an input entry comprising a text string; identifying segmentation information from the input entry; and generating a candidate text string from the text string of the input entry based on the segmentation information.

According to the second aspect, the method further comprising: associating the entire text string with the candidate text string when the segmentation information is not available.

According to the third aspect, the method of the second aspect further comprising: generating a normalized count for the candidate text string; and comparing the comparing the normalized count with a predetermined threshold value.

According to the fourth aspect, the method of the second aspect further comprising: comparing the candidate text string with a dictionary; and storing the candidate text string as a canonic text string in a database when the normalized count for the candidate exceeds the threshold value and the comparing determines that the candidate text string is not already stored in the dictionary.

According to the fifth aspect, the method of the third or fourth aspect further comprising: comparing the candidate text string with the database; determining if the candidate text string is misspelled based on the comparing; and generating an alternative text string when the candidate text string is misspelled.

According to the sixth aspect, the input entry input entry comprises a user query for a search engine, a script for instant messaging, or a user input for an input method editor.

According to the seventh aspect, the text string comprises one or more words in a non-Roman language.

According to the eighth aspect, the segmentation information comprises a user-generated segmentation that can be used to distinguish between words or phrases in the text string.

According to the ninth aspect, the candidate text string comprises one or more name entities or new words.

According to the tenth aspect, the dictionary comprises a proper noun dictionary.

According to the eleventh aspect, the non-Roman language is Chinese, Japanese, or Korean language.

According to the twelfth aspect, the user-generated segmentation comprises a space, a tab, a quotation mark, a parenthesis, or a punctuation mark.

According to the thirteenth aspect, the name entities comprise idioms, proverbs, and names of people, organization, or places.

According to the fourteenth aspect, the new words comprise words not currently included in dictionaries.

According to the fifteenth aspect, the present application provides a processing engine to cause a processing device to perform functions, comprising: receiving an input entry comprising a text string; identifying segmentation information from the input entry; and generating a candidate text string from the text string of the input entry based on the segmentation information.

According to the sixteenth aspect, the processing engine of the sixteenth aspect further causing the processing device to perform functions comprising: associating the entire text string with the candidate text string when the segmentation information is not available.

According to the seventeenth aspect, the processing engine of the sixteenth aspect further causing the processing device to perform functions comprising: generating a normalized count for the candidate text string; and comparing the normalized count with a predetermined threshold value.

According to the eighteenth aspect, the processing engine of the sixteenth aspect further causing the processing device to perform functions comprising: comparing the candidate text string with a dictionary; and storing the candidate text string as a canonic text string in a database when the normalized count for the candidate exceed the threshold value and the comparing determines that the candidate text string is not already stored in the dictionary.

According to the nineteenth aspect, the processing engine of seventeenth or eighteenth aspect further causing the processing device to perform functions comprising: comparing the candidate text string with the database; determining if the candidate text string is misspelled based on the comparing; and generating an alternative text string when the candidate text string is misspelled.

According to the twentieth aspect, the present application provides a system, comprising: an input entry component configured to allow a user to enter a text string; means for generating a candidate text string from the input text string; and a database. The database is configured to determine if the candidate text string is already in the database and store the candidate text string in the database when the candidate text string is not already stored in the database.

According to the twenty-first aspect, the present application provides a system, comprising: means for receiving an input entry comprising a text string; means for identifying segmentation information from the input entry; and means for generating a candidate text string from the text string of the input entry based on the segmentation information.

According to the twenty-second aspect, the present application provides a processing engine, comprising: means for receiving an input entry comprising a text string; means for identifying segmentation information from the input entry; and means for generating a candidate text string from the text string of the input entry based on the segmentation information.

According to the twenty-third aspect, the present application provides a computer program product which is tangibly encoded on a program carrier and operable to cause a data processing device to perform operations comprising: a step of receiving an input entry comprising a text string; a step of identifying segmentation information from the input entry; and a step of generating a candidate text string from the text string of the input entry based on the segmentation information.

Where appropriate, the systems and the functional operations described in this specification can be implemented in digital electronic circuitry, or in computer software, firmware, or hardware, including the structural means disclosed in this specification and structural equivalents thereof, or in combinations of them. The techniques can be implemented as one or more computer program products, i.e., one or more computer programs tangibly embodied in an information carrier, e.g., in a machine readable storage device or in a propagated signal, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification can be performed by one or more programmable processors executing one or more computer programs to perform the described functions by operating on input data and generating output. The processes and logic flows can also be performed by, and apparatus can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, the processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, aspects of the described techniques can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The techniques can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications can be made without departing from the spirit and scope of the described implementations. For example, the system and method can be implemented on a server site such as on a search engine or can be implemented on a client site such as a computer, e.g., downloaded, to provide spelling corrections for text entries in a document or interface with a remote server such as a search engine. Moreover, the client machine and the server can be implemented in one machine, e.g., when the user performs a desktop search on her own machine.

Furthermore, as noted above, the system and method can be implemented in non-Roman-based language, e.g., CJK language, input method editors. The suggestion of the next character/word in an input word sequence can be provided using the detected name entity/new word list. For example, suppose both phrases [symbol] and [symbol] have been detected as part of the name entity/new word database. In a Chinese input method editor, when the user has entered the first three characters [symbol] , the editor can automatically provide a suggestion of [symbol] and [symbol] as the next character. In this manner, the user can simply pick one of the desired characters and does not have to manually enter the next character. Accordingly, other implementations are within the scope of the following claims.

1. A computer-implemented method comprising:
receiving an input entry comprising a text string;
identifying segmentation information from the input entry, wherein the segmentation information includes one or more user generated segmentations; and
generating a candidate text string from the text string of the input entry based on the segmentation information.

2. The method of claim 1, further comprising:
associating the entire text string with the candidate text string when the segmentation information is not available.

3. The method of claim 2, further comprising:
generating a normalized count for the candidate text string; and
comparing the normalized count with a predetermined threshold value.

4. The method of claim 3, further comprising:
comparing the candidate text string with a dictionary; and
storing the candidate text string as a canonic text string in a database when the normalized count for the candidate exceeds the threshold value and the comparing determines that the candidate text string is not already stored in the dictionary.

5. The method of claim 4, further comprising:
comparing the candidate text string with the database;
determining if the candidate text string is misspelled based on the comparing; and
generating an alternative text string when the candidate text string is misspelled.

6. The method of claim 1, wherein the input entry comprises a user query for a search engine, a script for instant messaging, or a user input for an input method editor.

7. The method of claim 1, wherein the text string comprises one or more words in a non-Roman language.

8. The method of claim 1, wherein a user-generated segmentation distinguishes between words or phrases in the text string.

9. The method of claim 1, wherein the candidate text string comprises one or more name entities or new words.

10. The method of claim 3, wherein the dictionary comprises a proper noun dictionary.

11. The method of claim 7, wherein the non-Roman language is Chinese, Japanese, or Korean language.

12. The method of claim 8, wherein the user-generated segmentation comprises a space, a tab, a quotation mark, a parenthesis, or a punctuation mark.

13. The method of claim 9, wherein the name entities comprise idioms, proverbs, and names of people, organization, or places.

14. The method of claim 9, wherein the new words comprise words not currently included in dictionaries.

15. A processing engine to cause a processing device to perform functions comprising:
receiving an input entry comprising a text string;
identifying segmentation information from the input entry, wherein the segmentation information includes one or more user-generated segmentations; and
generating a candidate text string from the text string of the input entry based on the segmentation information.

16. The processing engine of claim 15, further causing the processing device to perform functions comprising:
associating the entire text string with the candidate text string when the segmentation information is not available.

17. The processing engine of claim 16, further causing the processing device to perform functions comprising:
generating a normalized count for the candidate text string; and
comparing the normalized count with a predetermined threshold value.

18. The processing engine of claim 17, further causing the processing device to perform functions comprising:
comparing the candidate text string with a dictionary;
storing the candidate text string as a canonic text string in a database when the normalized count for the candidate exceeds the threshold value and the comparing determines that the candidate text string is not already stored in the dictionary.

19. The processing engine of claim 18, further causing the processing device to perform functions comprising:
comparing the candidate text string with the database;
determining if the candidate text string is misspelled based on the comparing; and
generating an alternative text string when the candidate text string is misspelled.

20. A system comprising:
an input entry component configured to allow a user to enter a text string;
means for generating a candidate text string from the input text string; and
a database configured to:
determine if the candidate text string is already in the database; and
store the candidate text string in the database when the candidate text string is not already stored in the database.

21. A system comprising:
means for receiving an input entry comprising a text string;
means for identifying segmentation information from the input entry, wherein the segmentation information includes one or more user-generated segmentations; and
means for generating a candidate text string from the text string of the input entry based on the segmentation information.

22. A processing engine, comprising:
means for receiving an input entry comprising a text string;
means for identifying segmentation information from the input entry, wherein the segmentation information includes one or more user-generated segmentations; and
means for generating a candidate text string from the text string of the input entry based on the segmentation information.
